(19) United States
(12) Patent Application Publication
(10) Pub. No.: US 2014/0175809 A1
(43) Pub. Date: Jun. 26, 2014

(54) CLOSURE MECHANISM FOR VEHICLE DOOR

(71) Applicant: Shigeru Takeuchi, Toyokawa-shi (JP)

(72) Inventor: Shigeru Takeuchi, Toyokawa-shi (JP)

(73) Assignee: SHIROKI CORPORATION, Kanagawa (JP)

(21) Appl. No.: 14/126,855

(22) PCT Filed: Jun. 12, 2012
(86) PCT No.: PCT/JP2012/065026

§ 371 Date: Dec. 17, 2013

(30) Foreign Application Priority Data
Jun. 24, 2011 (JP) 2011-140406

(51) Int. Cl. E05C 3/16

(52) U.S. Cl. CPC E05C 3/16
USPC 292/96

(57) ABSTRACT

A vehicle door includes a base member, a hook rotatable between a striker holding position and a striker releasing position, a ratchet provided on the base member and rotatable between a latching position at which the ratchet is engaged with the hook to hold the hook in the striker holding position and an unlatching position, a sector gear rotatably supported by the base member to rotates the hook toward the striker holding position, a pressing member projecting from the sector gear, a motor which rotates a pinion that is engaged with the sector gear, and a position detection sensor which issues a detection signal by being pressed by the pressing member upon the sector gear being positioned at a predetermined position, the position detection sensor being provided on a surface of the base member which faces the sector gear.

### TECHNICAL FIELD

The present invention relates to a closer mechanism, designed for a vehicle door, which is capable of locking and unlocking a door provided in the vehicle and capable of forcibly rotating the door in a locking direction.

### BACKGROUND ART

Patent Literature 1 discloses an example of known technologies of vehicle door closer mechanisms.

The vehicle body disclosed in Patent Literature 1 is provided in the rear thereof with a back door that is rotatably provided for opening and closing an opening formed in the rear of the vehicle. A striker is projected from the rear of the vehicle body, while a closer mechanism which is engaged with the striker to hold the back door in the closed position when the back door is closed is provided in the back door.

The closer mechanism is equipped with a lock unit which includes: a hook (latch) that is rotatable between a striker holding position where the hook is capable of being engaged with the striker and a striker release position where the hook is not capable of being engaged with the striker, and a ratchet (locking plate) that is rotatable between a latched position where the ratchet is engaged with the hook to hold the striker in the striker holding position and an unlatched position where the ratchet is not engaged with the hook. In addition, the closer mechanism is provided with a base member (base plate) which is fixed to the body (a casing which accommodates the hook and the ratchet) of the lock unit, and the base member is provided with a sector gear which rotates the hook toward the striker holding position by rotating in one direction, a motor having a rotary output shaft to which a gear that is engaged with the sector gear is fixed, a half-latch detection switch which detects the position of the hook in the rotational direction thereof, and a contact sector-gear-position detection sensor which can detect the position of the sector gear in the rotational direction thereof.

When the hook of the lock unit is spaced from the striker by the positioning of the door at the fully-opened position, the sector gear is located at a predetermined initial position.

Upon the half-latch detection switch detecting that the hook at the striker release position has rotated to the half-latched position, which is a predetermined position between the striker release position and the striker holding position, while remaining engaged with the striker by a rotation of the door from the fully-open position to a position in the vicinity of the fully-closed position, the motor rotates in one direction, and the gear rotated by the motor rotates the sector gear in the aforementioned one direction. Thereupon, the hook is forcibly rotated to the striker holding position by the sector gear, so that the door rotates to the fully-closed position. In addition, upon the hook rotating to the striker holding position, the ratchet rotates to the latched position to hold the hook in the striker holding position.

Additionally, upon the half-latch detection switch detecting that the hook has rotated to the striker holding position, the motor rotates in a direction reverse to the aforementioned one direction, so that the sector gear moves back to the initial position to come into contact with the sector-gear-position detection sensor. Thereupon, the sector-gear-position detection sensor detects that the sector gear has moved back to the initial position, so that the motor stops rotating.

### CITATION LIST

### Patent Literature

PATENT LITERATURE 1: Japanese Unexamined Patent Publication No. 2001-182407

### SUMMARY OF INVENTION

### Technical Problem

Since, in addition to the closer mechanism, various members are also disposed inside the back door, the closer mechanism needs to be miniaturized as much as possible to efficiently utilize the internal space of the back door.

However, in the closer mechanism disclosed in Patent Literature 1, since the sector-gear-position detection sensor is positioned on the outer peripheral side of the sector gear as viewed in the direction of the rotation center axis of the sector gear, the base member has been increased in size by an amount corresponding to the size of the sector-gear-position detection sensor; hence, it is difficult to miniaturize the closer mechanism.

The present invention provides a vehicle door closure mechanism which makes it possible to miniaturize the base member and the entire part while having a structure in which a sector gear and a position detection sensor, which detects the position of the sector gear in the rotational direction thereof, are provided on the base member.

### Solution To Problem

The closer mechanism for a vehicle door according to the present invention is characterized by including a base member which is fixed to one of a vehicle body and a door which opens and closes an opening of the vehicle body; a hook which is provided on the base member and is rotatable between a striker holding position at which the hook is engaged with a striker that is provided on, and projects from, the other of the vehicle body and the door, and a striker releasing position at which the hook is not engaged with the striker; a ratchet which is provided on the base member and rotatable between a latching position at which the ratchet is engaged with the hook to hold the hook in the striker holding position and an unlatching position at which the ratchet does not hold the hook in the striker holding position; a sector gear which is rotatably supported by the base member and rotates the hook toward the striker holding position by rotating in one direction; a pressing member which is provided on and projects from the sector gear; a motor which rotates a pinion that is engaged with the sector gear to drive and rotate the sector gear in the one direction; and a position detection sensor which issues a detection signal by being pressed by the pressing member upon the sector gear being positioned at a predetermined position, the position detection sensor being provided on a facing surface of the base member which faces the sector gear.

The sector gear can be made of metal and the pressing member can be made of resin.

The facing surface of the base member and the pressing member can be made to face each other with a clearance formed therebetween.

The sector gear can include a proximal facing portion, a distance of which from the facing surface of the base member is small; and a spaced facing portion, a distance of which from the facing surface is greater than that from the proximal facing portion and which extends in a circumferential direction about a rotation center of the sector gear. The position detection sensor is provided on a portion of the facing surface which faces the spaced facing portion.

### Advantageous Effects of Invention

According to the present invention, the base member and the closer mechanism can be miniaturized compared with conventional closer mechanisms because the position detection sensor that detects the position of the sector gear in the rotational direction thereof is provided on a facing surface of the base member which faces the sector gear.

If the pressing member is made of resin like the invention claimed in claim 2, it becomes easy (easier than the case where the pressing member is made of metal) to form the pressing member into a desired shape. Therefore, the position detection sensor can detect the position of the sector gear more reliably.

According to the invention claimed in claim 3, when an external force, in a direction to make the sector gear tilt toward the base member, acts on the sector gear from the pinion or the like, the sector gear is prevented from tilting by contacting of the pressing member with the base member, which enables the sector gear to rotate smoothly.

According to the invention claimed in claim 4, a space in which the position detection sensor can be disposed and which can prevent the sector gear and the position detection sensor from interfering with each other, even if the sector gear rotates, becomes easy to form between the base member (the facing surface thereof) and the sector gear.

### BRIEF DESCRIPTION OF DRAWINGS

FIG. 1 is a side view of a vehicle to which the present invention is applied;

FIG. 2 is an exploded perspective view of a door lock device;

FIG. 3 is a perspective view of a hook of the door lock device;

FIG. 4 is a perspective view of a ratchet of the door lock device;

FIG. 5 is a perspective view of a closing lever and an interlinking lever of the door lock device;

FIG. 6 is a perspective view of an opening lever of the door lock device;

FIG. 7 is a perspective view of a sector gear and a pressing member of the door lock device;

FIG. 8 is a perspective view of a control board and a covering member in a separated state;

FIG. 9 is an illustration viewed in the direction of the arrow A shown in FIG. 8 when the control board and the covering member are assembled;

FIG. 10 is a perspective view of a combination of the control board and the covering member and a body member in a mutually separated state;

FIG. 11 is a perspective view of an electronic control unit (ECU) in a completed state;

FIG. 12 is a cross sectional view taken along the arrow line XII-XII shown in FIG. 15; and

FIG. 13 is a plan view of the door lock device when the back door is positioned in the vicinity of the fully-closed position;

FIG. 14 is a plan view of the door lock device in a half-latched state;

FIG. 15 is a plan view of the door lock device in a state where the operation to a fully-latched state has been completed;

FIG. 16 is a cross sectional view taken along the arrow line XVI-XVI shown in FIG. 13;

FIG. 17 is a perspective view of the electronic control unit (ECU) and peripheral members thereof when the back door is in the fully-open position;

FIG. 18 is a timing chart showing a normal operating state of the door lock device;

FIG. 19 is a timing chart in the case where an opening (closure-canceling) operation has been performed electrically at some point during the operation from the half-latched state to the fully-latched state; and

FIG. 20 is a timing chart in the case where the opening (canceling of closed state) operation has been performed mechanically at some point during the operation from the half-latched state to the fully-latched state.

### DESCRIPTION OF EMBODIMENT

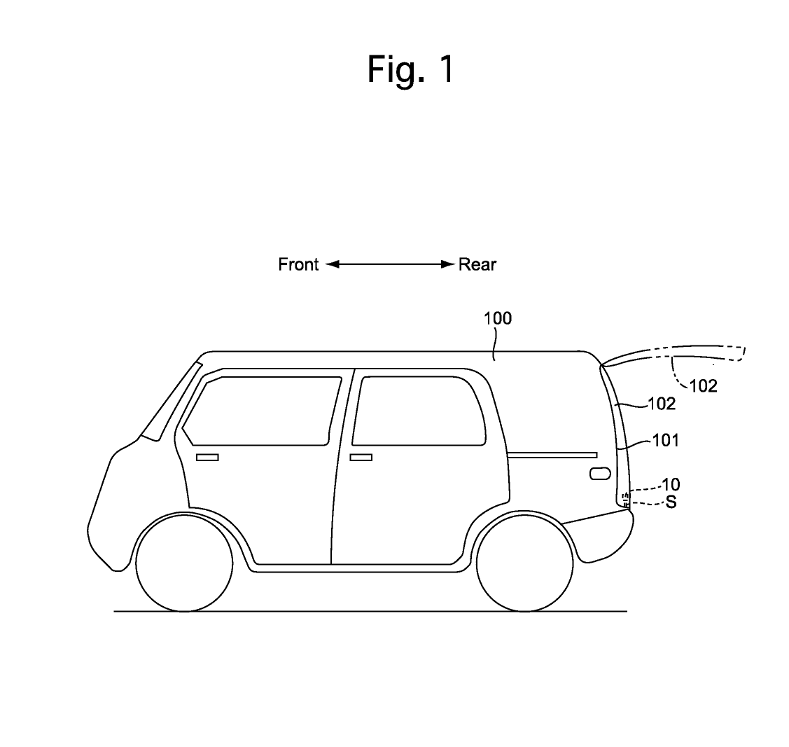

A door lock device according to the present invention will be described below based on the accompanying drawings. The lock mechanism (door closer) 10 shown in the drawings is fixed to a back door 102 that is rotatably mounted, about a rotational axis extending in the leftward/rightward direction (horizontal direction), to the upper edge of a rear opening 101 of a vehicle body 100. The vehicle body 100 is provided at the lower edge of the rear opening 101 with a striker S (FIGS. 1 and 13 through 15) which is engaged with and disengaged from the lock mechanism 10. Furthermore, it is possible to reverse the positional relationship between the lock mechanism 10 and the striker S.

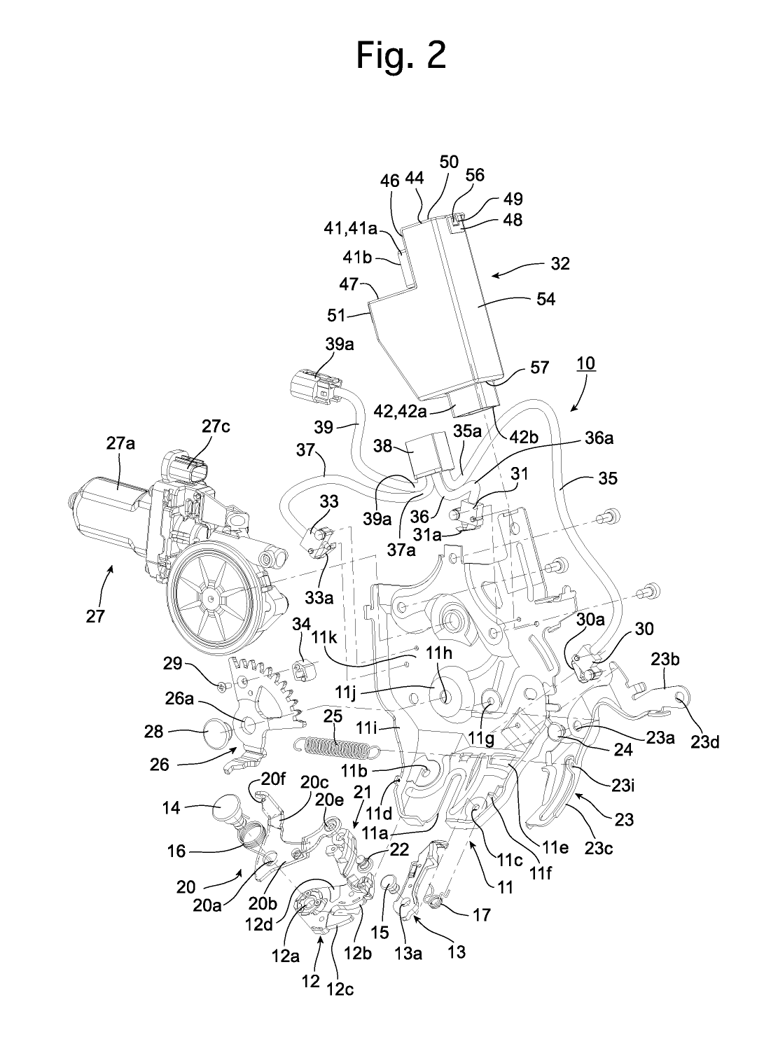

As shown in FIG. 2, the lock mechanism 10 is provided with a base plate 11 made of metal which is fixedly mounted to the back door 102. A striker entry groove 11a, into which the striker S can enter, is formed in the base plate 11, and pivots 14 and 15 are fixed to pivot support holes 11b and 11c positioned on both sides of the striker entry groove 11a, respectively. The pivot 14 is inserted into a pivotal hole 12a formed in a hook 12, and the hook 12 is supported by the pivot 14 to be rotatable about the pivot 14. The pivot 15 is inserted into a pivotal hole 13a formed in a ratchet 13, and the ratchet 13 is supported by the pivot 15 to be rotatable about the pivot 15.

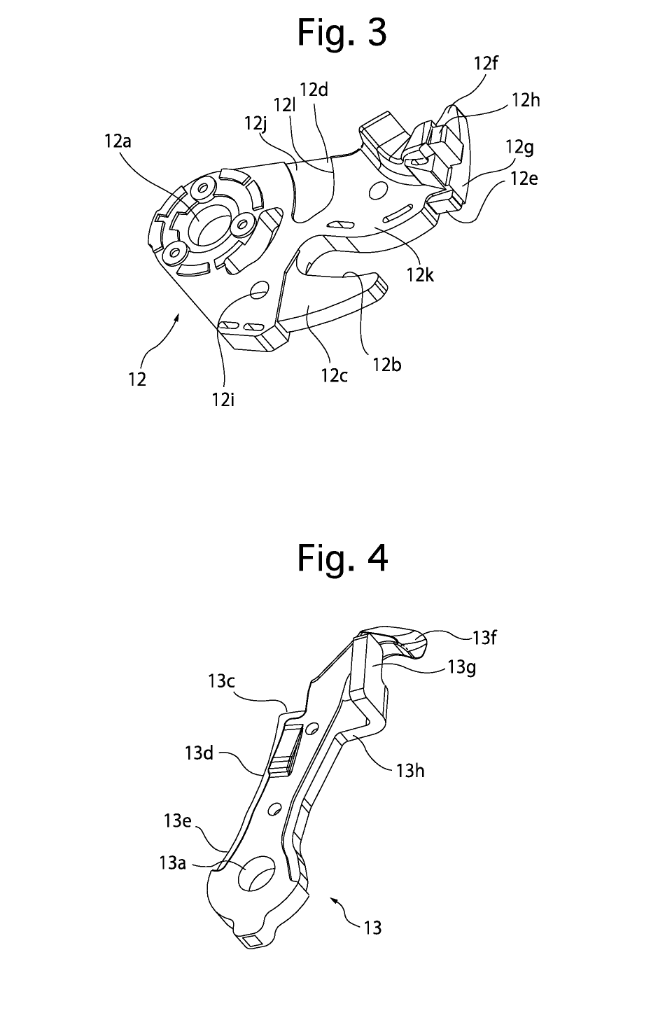

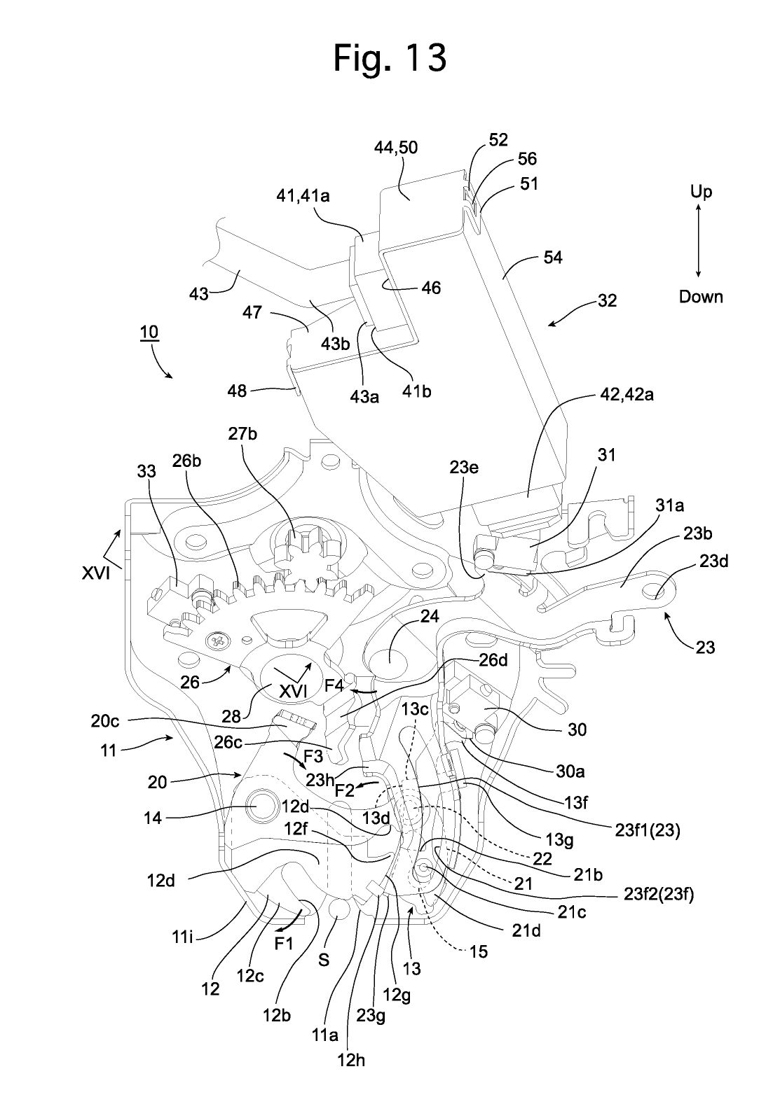

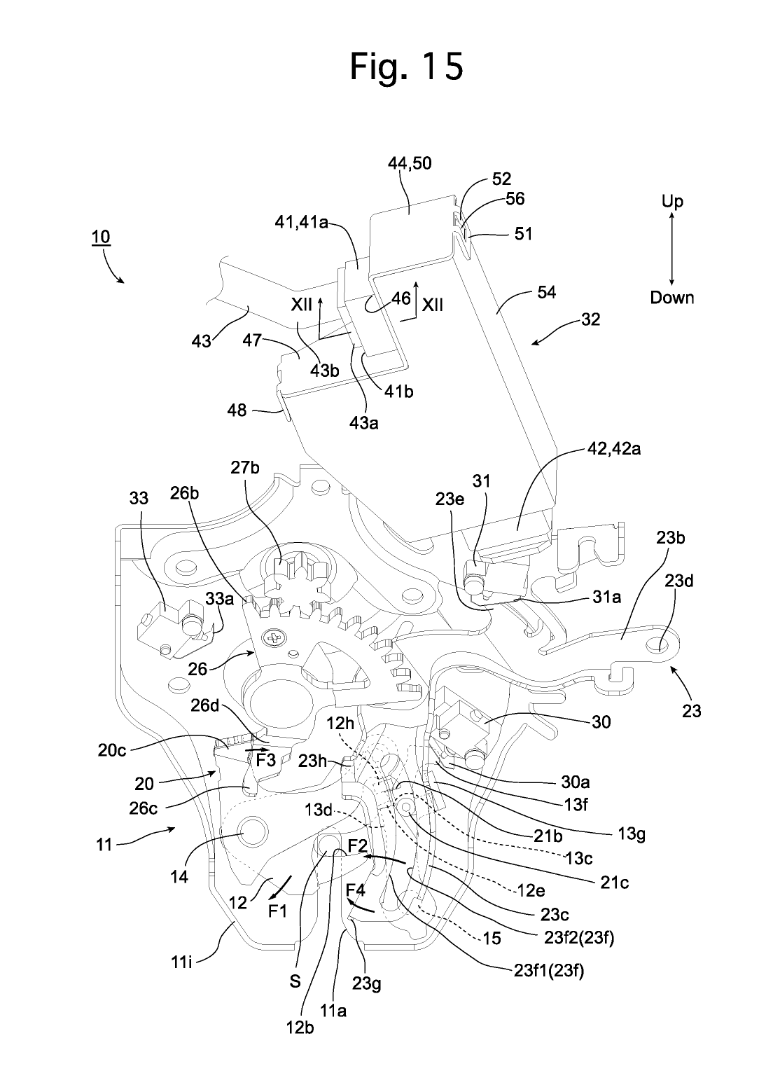

As shown in FIG. 3, a hook body 12j which constitutes the base of the hook 12 is made of metal, and the hook body 12j is provided with a striker holding groove 12b which is elongated in a substantially radial direction about the pivotal hole 12a, and a first leg portion 12c and a second leg portion 12d, which are positioned on respective sides of the striker holding groove 12b. The hook 12 is provided, in the vicinity of an end of the second leg portion 12d on a side thereof which faces the striker holding groove 12b, with a ratchet-engaging stepped portion (engaging portion) 12e, and is provided on the opposite side thereof with a ratchet pressure projection (ratchet controller) 12f. In addition, an end of the second leg portion 12d which connects the ratchet-engaging stepped portion 12e and the ratchet pressure projection 12f to each other is formed into a convex-shaped circular arc surface (ratchet controller/ratchet holder) 12g. Additionally, a coupling projection (opening lever holder) 12h is formed on the second leg portion 12d to project in a direction away from the base plate 11. The hook 12 is rotatable between a striker releasing position shown in FIG. 13 and a striker holding position shown in FIG. 15, and is biased to rotate toward the striker releasing position (clockwise direction with respect to FIGS. 13 through 15) by a torsion spring 16. The torsion spring 16 is provided with a coiled portion which surrounds the pivot 14 and a pair of spring ends which are engaged with a spring hooking hole 12i of the hook 12 and a spring hooking hole 11d of the base plate 11, respectively. A surface of the hook body 12j is covered with a hook cover 12k made of resin. However, the hook cover 12k exposes the first leg portion 12c, the ratchet-engaging stepped portion 12e, the ratchet pressure projection 12f, the circular arc surface 12g and the coupling projection 12h and is provided with a cutout 121 for exposing the base of the second leg portion 12d.

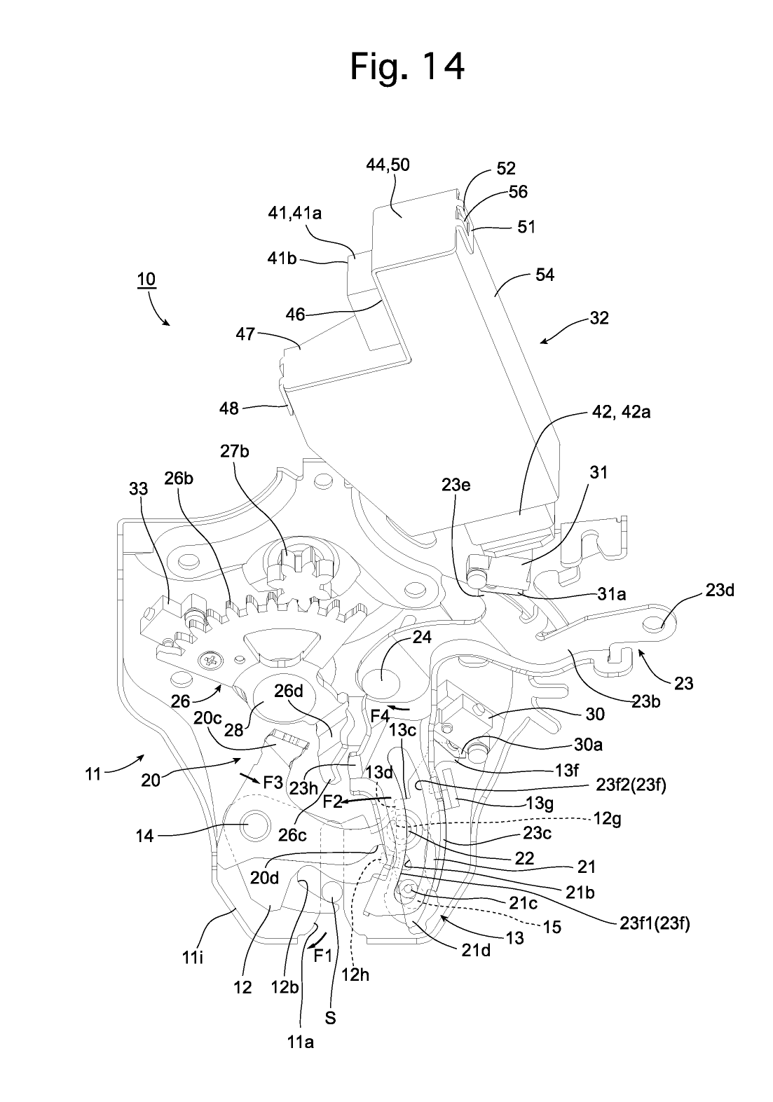

As shown in FIG. 4, the ratchet 13 is provided with a guide projection (not shown) which is engaged with a ratchet guide groove 11e formed in the base plate 11 to be freely slidable thereon. The ratchet 13 is provided, on a side thereof facing the hook 12, with a rotation-restriction stepped portion 13c which is engageable with the ratchet-engaging stepped portion 12e. A concave-shaped circular-arc surface portion (ratchet controller/ratchet holder) 13d, which corresponds in shape to the circular arc surface 12g of the hook 12, is formed on a side surface of the ratchet 13 that is continuous with the rotation-restriction stepped portion 13c, and a smoothly-stepped portion (ratchet controller) 13e is formed on a portion of the circular-arc surface portion 13d in the vicinity of the base end of the ratchet 13 toward the pivotal hole 13a. Additionally, the ratchet 13 is provided, in the vicinity of the end thereof that is distant from the pivotal hole 13a, with a switch operating piece 13f, and is provided with a pressed piece (ratchet controller/interlinking-lever linkup portion) 13g on the opposite side of the ratchet 13 from the circular-arc surface portion 13d. The ratchet 13 is rotatable between a latching position (FIGS. 13 and 15) in which the ratchet 13 is positioned close to the hook 12 so that the rotation-restriction stepped portion 13c is positioned on a moving path of the ratchet-engaging stepped portion 12e of the hook 12 (in which the rotation-restriction stepped portion 13c is engageable with the ratchet-engaging stepped portion 12e) and an unlatching position (FIG. 14) in which the rotation-restriction stepped portion 13c is retracted from a position on the moving path of the ratchet-engaging stepped portion 12e (in which the rotation-restriction stepped portion 13c is not engaged with the ratchet-engaging stepped portion 12e), and is biased to rotate toward the latching position (in the counterclockwise direction with respect to FIGS. 13 through 15) by a torsion spring (ratchet biaser) 17. The torsion spring 17 is provided with a coiled portion which surrounds the pivot 15 and a pair of spring ends which are engaged with a spring hooking portion 13h of the ratchet 13 and a spring hooking hole 11f (see FIG. 2) of the base plate 11, respectively.

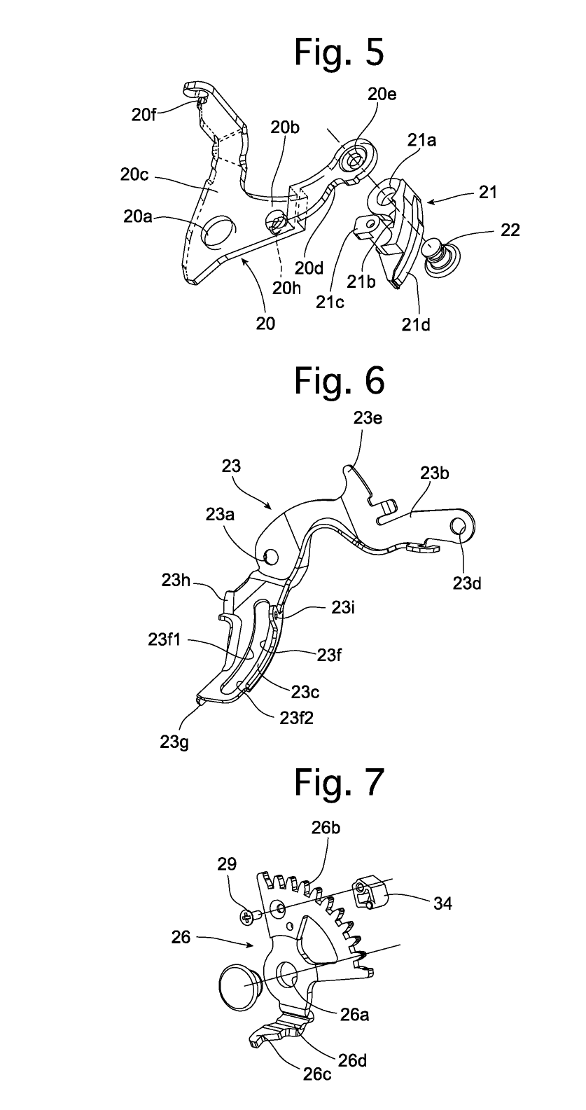

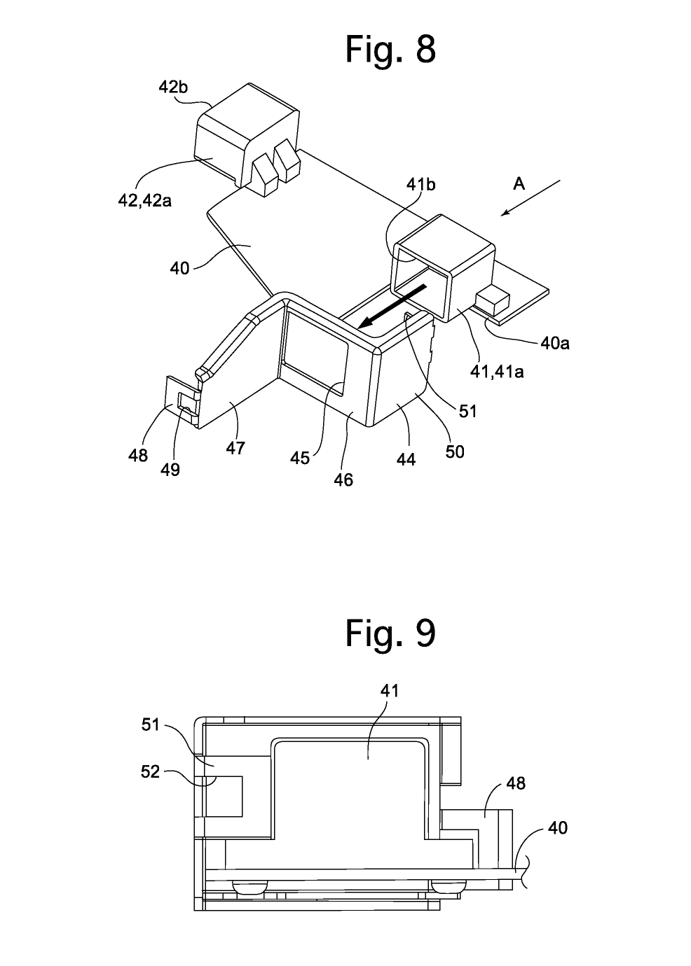

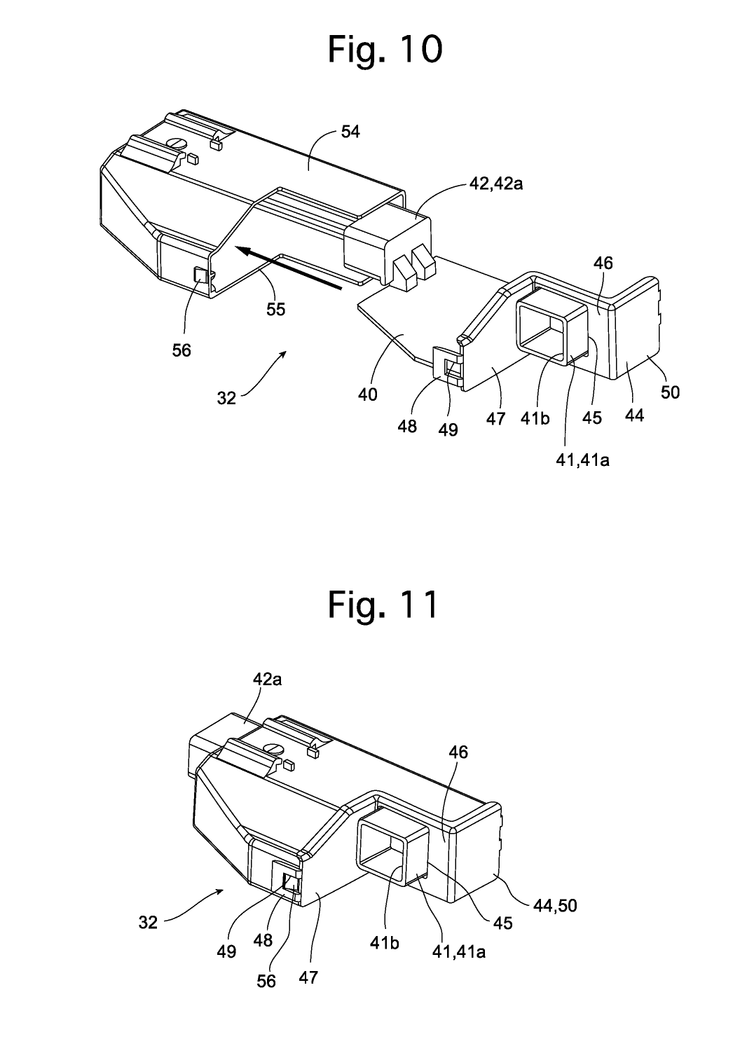

The pivot 14 is also inserted into a pivotal hole 20a of a closing lever 20, and the closing lever 20 is supported by the pivot 14 to be rotatable independently about the pivot 14 relative to the hook 12. As shown in FIG. 5, the closing lever 20 is substantially L-shaped, has a first arm 20b and a second arm 20c which extend radially about the pivotal hole 20a, and is rotatable between a draw-in releasing position (FIGS. 13 and 14) in which the closing lever 20 is positioned toward the striker releasing position of the hook 12 that rotates coaxially with the closing lever 20, and a draw-in position (FIG. 15) in which the closing lever 20 is positioned toward the striker holding position of the hook 12.

A recess 20d with which the coupling projection 12h of the hook 12 can come into contact, and a pivot support hole 20e in which a pivot 22 is inserted to be supported thereby are formed on a portion of the closing lever 20 in the vicinity of the end of the first arm 20b. In addition, a sliding projection 20h which slides on the second leg portion 12d through the cutout 121 is projected from a surface of the closing lever 20 which faces the hook 12. The pivot 22 is inserted into a pivotal hole 21a of an interlinking lever (ratchet controller) 21, and the interlinking lever 21 is pivoted on the closing lever 20 to be rotatable about the pivot 22. As shown in FIG. 5, the interlinking lever 21 is provided on a side thereof with a coupling recess 21b having a shape corresponding to the shape of the coupling projection 12h of the hook 12, and the interlinking lever 21 is rotatable between a coupling position (in which the interlinking lever 21 is engageable with the coupling projection 12h) (FIGS. 14 and 15), in which the coupling recess 21b is positioned on a moving path of the coupling projection 12h of the hook 12, and a coupling disengaging position (in which the interlinking lever 21 is not engaged with the coupling projection 12h) (FIG. 13), in which the coupling recess 21b is retracted from a position on the moving path of the coupling projection 12h of the hook 12. The interlinking lever 21 is further provided in the vicinity of the coupling recess 21b with a control projection 21c which projects in a direction away from the base plate 11, and is provided with a ratchet pressure projection 21d at the end of the interlinking lever 21 on the opposite side from the base end thereof that includes the pivotal hole 21a.

A pivot 24 is fixed to a pivot support hole 11g of the base plate 11, and a pivotal hole 23a formed in an opening lever 23 is rotatably fitted on the pivot 24. As shown in FIG. 6, the opening lever 23 is provided with a first arm 23b and a second arm (arm portion) 23c which extend in different directions with the pivotal hole 23a as the center. The opening lever 23 is provided in the vicinity of an end of the first arm 23b with a handle linking hole that is linked with an end of an emergency release handle not shown in the drawings, and is provided at a midpoint between the pivotal hole 23a and a handle interlinking hole 23d with a switch operating piece 23e. In addition, the first arm 23b is linked with an end of a wire, the other end of which is linked with a key apparatus not shown in the drawings. The second arm 23c is positioned to generally overlay the ratchet 13 as viewed in a plan view as shown in FIGS. 13 through 15, and is provided with an interlinking-lever control groove (ratchet controller) 23f in which the control projection 21c of the interlinking lever 21 is inserted, a rotation restriction wall (opening lever holder) 23g that is capable of coming in contact with the coupling projection 12h of the hook 12, and a gear contact portion 23h which faces a sector gear 26, which will be discussed later. The interlinking-lever control groove 23f is a circular-arc-shaped elongated hole which progressively increases in width toward the end of the second arm 23c (toward the draw-in releasing position of the closing lever 20) from the side closer to the pivotal hole 23a (toward the draw-in position of the closing lever 20) and includes an inner arc surface (projection operating surface) 23f1 and an outer arc surface (opposed guide surface) 23f2, the central axes of which are mutually different. The opening lever 23 is rotatable between a closing position (FIGS. 14 and 15) at which the second arm 23c thereof, which has the interlinking-lever control groove 23f, is displaced toward the latching position of the ratchet 13, and an opening position (FIG. 13) at which the second arm 23c is displaced toward the unlatching position of the ratchet 13.

An extension spring (closing lever biaser/control lever biaser) 25 is extended and installed between a spring hook 20f formed on the second arm 20c of the closing lever 20 and a spring hook 23i formed on the second arm 23c of the opening lever 23. The closing lever 20 is biased to rotate toward the aforementioned draw-in releasing position (clockwise direction with respect to FIGS. 13 through 15) by the extension spring 25, while the opening lever 23 is biased to rotate toward the aforementioned closing position (clockwise direction with respect to FIGS. 13 through 15) by the extension spring 25.

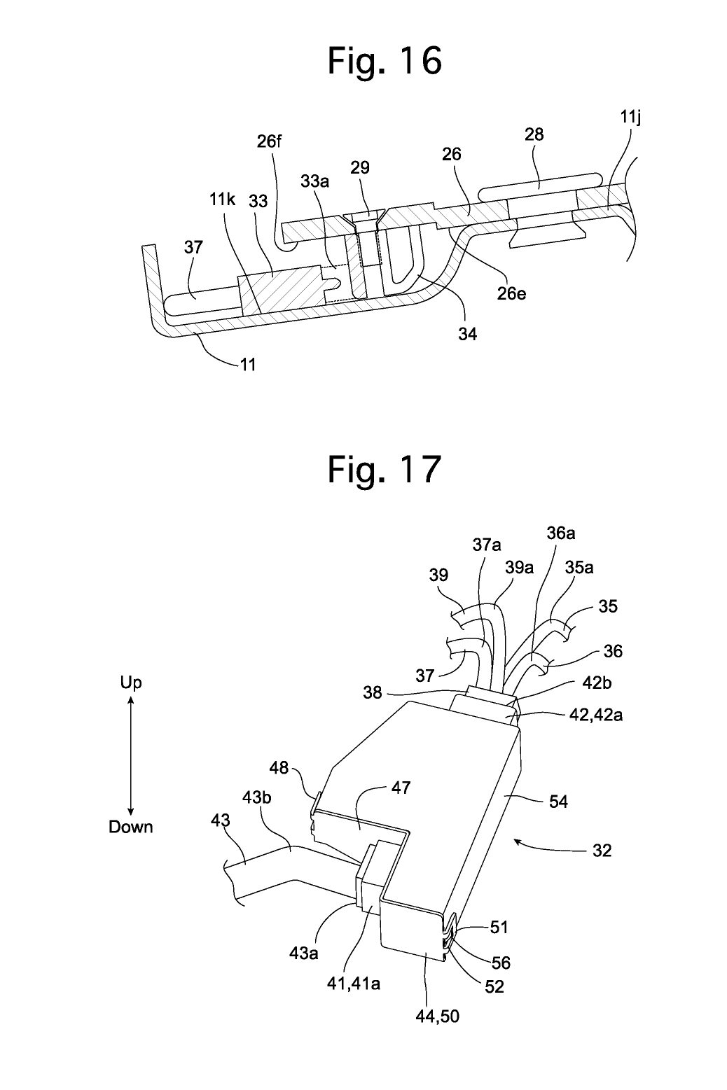

A pivotal hole 11h is formed in a support projection 11j which is projected from a portion of the base plate 11 in the vicinity of the center thereof, and a portion of the base plate 11 around the support projection 11j is formed as an annular stepped portion 11k which extends in a circumferential direction about the support projection 11j. A pivot 28 is fixed into the pivotal hole 11h, and a pivotal hole 26a of the sector gear 26 that is made of metal is rotatably fitted on the pivot 28. The sector gear 26 is provided with a gear portion 26b which is formed on the outer edge of a sector portion of the sector gear 26 about the pivotal hole 26a, an opening lever operating piece 26c which is capable of coming in contact with the gear contact portion 23h of the opening lever 23, and a closing lever operating portion 26d which is continuous with the opening lever operating piece 26c and capable of engaging with the second arm 20c of the closing lever 20. In addition, a portion of the sector gear 26 which faces the annular stepped portion 11k is formed as a proximal facing portion 26e, and the outer peripheral portion of the proximal facing portion 26e is formed as a spaced facing portion 26f (extending in a circumferential direction about the pivotal hole 26a of the sector gear 26) which is recessed one step compared with the proximal facing portion 26e. Therefore, the distance between the spaced facing portion 26f and the annular stepped portion 11k is greater than the distance between the proximal facing portion 26e and the support projection 11j (FIG. 16). As shown in FIG. 7, the opening lever operating piece 26c and the closing lever operating portion 26d are substantially orthogonal to the other part of the sector gear 26, and the closing lever operating portion 26d is formed to have a greater width than that of the opening lever operating piece 26c. Additionally, a pressing member 34 made of synthetic resin is fixed to the spaced facing portion 26f by a screw 29, and the pressing member 34 forms a minute clearance between the pressing member 34 and the annular stepped portion 11k. A motor unit 27 fixed on the base plate 11 is provided with a pinion 27b which is driven to rotate forward and reverse by a motor 27a, and the pinion 27b is engaged with the gear portion 26b. The motor unit 27 and the sector gear 26 constitute a motor-operated driving mechanism.

A ratchet detection switch (detector/first switch) 30 and an opening lever detection switch (detector/second switch) 31 are mounted on the base plate 11. The ratchet detection switch 30 is a switch which can be pressed by the switch operating piece 13f that is provided on the ratchet 13, and the opening lever detection switch 31 is a switch which can be pressed by the switch operating piece 23e that is provided on the opening lever 23. More specifically, the ratchet detection switch 30 is in a switch-OFF state, in which the switch operating piece 13f is spaced from a switch leaf 30a, when the ratchet 13 is in the latching position shown in FIGS. 13 and 15, and the switch operating piece 13f presses the switch leaf 30a to thereby turn ON the ratchet detection switch 30 upon the ratchet 13 being rotated to the unlatching position shown in FIG. 14. In addition, the opening lever detection switch 31 is in a switch-OFF state in which the switch operating piece 23e is spaced from a switch leaf 31a when the opening lever 23 is in the closing position shown in FIGS. 14 and 15, and the switch operating piece 23e presses the switch leaf 31a to thereby turn ON the opening lever detection switch 31 upon the opening lever 23 being rotated to the opening position shown in FIG. 13. The ON/OFF states of the ratchet detection switch 30 and the opening lever detection switch 31 are input to an electronic control unit (ECU) 32, and the electronic control unit 32 controls the operation of the motor unit 27 in a manner which will be discussed later.

The lock mechanism 10 is provided with a sector gear position detection sensor 33 (FIGS. 2, 13, etc.), provided with a switch leaf 33a, for detecting an initial position of the sector gear 26 and an opening operation switch (not shown) for performing a motor-driven opening operation. As shown in the drawings, the sector gear position detection sensor 33 is fixed to the annular stepped portion 11k of the base plate 11 by a screw, and both the switch leaf 33a and the pressing member 34 lie on a curved line having a circular arc shape which is parallel to the rotational direction of the sector gear 26.

As shown in FIG. 2, wire harnesses 35, 36 and 37, which are flexible as a whole and are provided with harnesses made of a conductive material and tubular sheaths made of an insulating material that cover the peripheries of the harnesses, are connected at one end of the wire harnesses 35, 36 and 37 to the ratchet detection switch 30, the opening lever detection switch 31 and the sector gear position detection sensor 33, respectively, and the other end of the wire harnesses 35, 36 and 37 are connected to a connector 38. An end of a wire harness 39 which is identical in structure to the wire harnesses 35, 36 and 37 is connected to the connector 38, and the wire harness 39 is provided at the other end thereof with a connector 39a which is connected to a socket 27c of the motor unit 27. As shown in FIGS. 2 and 17, bent portions 35a, 36a, 37a and 39a are formed on portions of the wire harnesses 35, 36, 37 and 39 in the vicinity of the ends thereof on the connector 38 side, respectively. Accordingly, when the back door 102 is positioned in the vicinity of the fully-closed position or the fully-closed position, the wire harnesses 35, 36, 37 and 39 extend obliquely downwards from the connector 38 toward the bent portions 35a, 36a, 37a and 39a, respectively, and portions of the wire harnesses 35, 36, 37 and 39 beyond the bent portions 35a, 36a, 37a and 39a extend obliquely upward from the bent portions 35a, 36a, 37a and 39a, respectively.

The electronic control unit 32 is configured of a combination of a control board 40 that is integral with an upper connector 41 (second connector) and a lower connector 42 (first connector), a covering member 44 and a body member 54.

One side of the control board 40 is formed as a circuit-forming surface on which a circuit has been printed, and a notch 40a having an L-shape is formed on the control board 40 at a corner thereof. The upper connector 41 is provided with a plurality of contacts (pins) which are soldered to the circuit of the control board 40 and a tubular cover 41a having a rectangular tubular cross sectional shape which is made of an insulating hard resin and covers the periphery of the contacts (group of contacts). The lower connector 42 is provided with a plurality of contacts (pins) which are soldered to the circuit of the control board 40 and a tubular cover 42a having a rectangular tubular cross sectional shape which is made of an insulating hard resin and covers the periphery of the contacts (group of contacts). As shown in the drawings, each of the tubular covers 41a and 42a is open only at one end thereof in the lengthwise direction, the opening of the tubular cover 41a constitutes an upper opening 41b (opening) and the opening of the tubular cover 42a constitutes a lower opening 42b. In addition, the axes of the tubular covers 41a and 42a are orthogonal to each other.

The covering member 44 that is made of an insulating hard resin is integrally provided with an inclined flat plate portion 46 in which an upper connecting opening 45 that is substantially identical in cross sectional shape to the tubular cover 41a is formed, a stepped portion 47 which extends from an end of the inclined flat plate portion 46 in a direction orthogonal to the inclined flat plate portion 46, a locking lug 48 which extends from an end of the inclined flat plate portion 47 in the direction opposite to the inclined flat plate portion 46, an end face portion 50 which extends from the other end of the inclined flat plate portion 46 in the direction opposite to the stepped portion 47 and a locking lug 51 which extends from an end of the end face portion 50 in the same direction as the engaging lug 48. A locking hole 49 is formed in the locking lug 48; likewise, a locking hole 52 similar to the locking hole 49 is formed in the locking lug 51.

The body member 54 that is made of an insulating hard resin is a hollow box-shaped member. One end face of the body member 54 in the lengthwise direction thereof is totally open and provided with an L-shaped cutout 55 at the one end thereof. A locking lug 56 is provided on a side of the body member 54 and projects therefrom, and a locking lug 56 is also provided on another side of the body member 54 and projects therefrom. In addition, a lower connecting opening 57 substantially identical in cross sectional shape to the tubular cover 42a is formed on the other end surface of the body member 54 in the lengthwise direction thereof.

The control board 40 is integrated with the covering member 44 by fitting the tubular cover 41a into the upper connecting opening 45. Upon the control board 40 being integrated with the covering member 44, an end of the tubular cover 41a projects outside the upper connecting opening 45, and the notch 40a comes into contact with inner surfaces of the inclined flat plate portion 46 and the stepped portion 47. In addition, the combination of the control board 40 and the covering member 44 is made integral with the body member 54 by fitting the tubular cover 42a into the lower connecting opening 57 after inserting the lower connector 42 into the inside of the body member 54 from the end-face opening of the body member 54 on the cutout 55 side. Upon this combination being integrated with the body member 54, the inclined flat plate portion 46, the stepped portion 47 and the end face portion 50 cover the open end face of the body member 54 on the cutout 55 side while the locking hole 49 of the locking lug 48 and the locking hole 52 of the locking lug 51 are engaged with the two locking lugs 56 of the body members 54.

The electronic control unit 32 is fixed to the end of the base plate 11 on the opposite side from the striker entry groove 11a by a plurality of screws. As shown in the drawings, the axis of the electronic control unit 32 (the axis of the tubular cover 42a and the inclined flat plate portion 46) are inclined with respect to the vertical direction, while the axis of the tubular cover 41a is inclined with respect to the horizontal direction.

A connector (male connector) 43a (see FIGS. 13, 15 and 17) provided at an end of a wire harness 43 (having the same structure as the wire harnesses 35, 36 and 37) electrically connected to a battery (not shown; for supplying power to the motor 27a, the ratchet detection switch 30, the opening lever detection switch 31, the electronic control unit 32, and the sector gear position detection switch 33, etc.) provided in the vehicle body 100 is connected to the tubular cover 41a, and the group of contacts of the connector 43a contact the aforementioned group of contacts of the upper connector 41 (female connector) that are positioned in the tubular cover 41a of the upper connector 41. The reason why the connector (male connector) 43a, which is provided at an end of the wire harness 43 that is electrically connected to the battery provided in the vehicle body 100, is connected to the upper connector 41 is that it is easier for the connector 43a to be connected to the upper connector 41 than to the lower connector 42. As shown in FIGS. 13, 15 and 17, the wire harness 43 is provided with a bent portion 43b in the vicinity of the end of the wire harness 43 on the connector 43a side. Accordingly, when the back door 102 is positioned in the vicinity of the fully-closed position or the fully-closed position, the wire harness 43 extends obliquely downwards from the connector 43a toward the bent portion 43b, and the portion of the wire harness 43 from the bent portion 43b onwards extends obliquely upward.

Additionally, the connector 38 is connected to the tubular cover 42a, and a group of contacts provided inside the connector 38 (which are connected to the end of each wire harness 35, 36 and 37) contacts the aforementioned group of contacts positioned inside the tubular cover 42a. The reason why the connector 38, which is provided at ends of the wire harnesses 35, 36, 37 and 39 that are electrically connected to the ratchet detection switch 30, the opening lever detection switch 31, the sector gear position detection switch 33 and the motor unit 27, is connected to the lower connector 42 is that the distances from the ratchet detection switch 30, the opening lever detection switch 31, the sector gear position detection switch 33 and the motor unit 27 to the connector 42 are smaller than those from the connector 41.

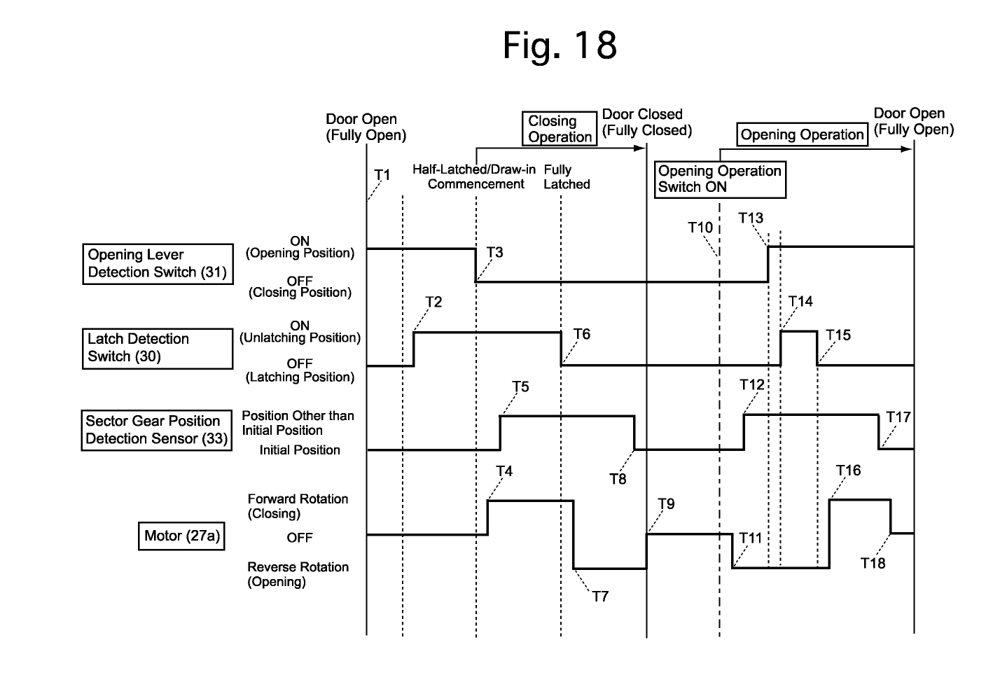

Operations of the lock mechanism 10 that has the above described structure will be hereinafter discussed with reference mainly to FIG. 13 onwards. FIGS. 13 through 15 show mechanical operations of the lock mechanism 10, and FIGS. 18 through 20 show timing charts showing the electrical control of the lock mechanism 10. F1, F2, F3 and F4 shown in the structural drawings represent the directions of spring biasing forces exerted on the hook 12, the ratchet 13, the closing lever 20 and the opening lever 23, respectively. The rotational directions of each component which will be discussed in the following descriptions are those in FIGS. 13 through 15. In addition, as for the driving direction of the motor 27a, the driving direction to close (lock) the door and the driving direction to unlock the door are referred to as the forward rotational direction and the reverse rotational direction, respectively.

First, normal operations shown in FIG. 18 will be discussed hereinafter. FIG. 13 shows the lock mechanism 10 in an open state of the back door 102 (in a state where it is positioned in the vicinity of the fully-closed position) which is shown by T1 in the timing chart shown in FIG. 18.

At this stage, the hook 12 is in the striker releasing position, in which the second leg portion 12d is positioned over the striker entry groove 11a while the first leg portion 12c is retracted from over the striker entry groove 11a, and the ratchet 13 is in the latching position, in which the ratchet 13 has been rotated in a direction to approach the hook 12. As described above, when the ratchet 13 is in the latching position, the ratchet 13 is in a state where the switch operating piece 13f does not press the switch leaf 30a of the ratchet detection switch 30, so that the ratchet detection switch 30 is in a switch-OFF state. The positions of the hook 12 and the ratchet 13 are maintained by the biasing force F1 of the torsion spring 16 and the biasing force F2 of the torsion spring 17, respectively. More specifically, the hook 12 is prevented from further rotating in the F1-direction by the engagement of a side surface thereof with an upright wall 11i of the base plate 11, and the ratchet 13 is prevented from further rotating in the F2-direction by the engagement of the aforementioned guide projection (not shown) with an end of the ratchet guide groove 11e.

In the door-open state of the back door 102 shown in FIG. 13, since the closing lever 20 is held in the draw-in releasing position by the engagement of a side surface of the closing lever 20 with the upright wall 11i, the control projection 21c of the interlinking lever 21 that is pivoted on the closing lever 20 via the pivot 22 is spaced upward from an end surface of the opening lever 23 on the lower end side of the interlinking-lever control groove 23f, and the closing lever 20 is prevented from further rotating in the F3-direction of the extension spring 25. At this stage, the biasing force F3 of the extension spring 25 that is exerted on the closing lever 20 acts in a direction to bring the control projection 21c of the interlinking lever 21 into pressing contact with the inner arc surface 23f1 of the interlinking-lever control groove 23f, while the interlinking lever 21 is held in the coupling disengaging position, in which the interlinking lever 21 cannot be coupled to the coupling projection 12h of the hook 12, by engagement of the control projection 21c with the inner arc surface 23f1. Additionally, the opening lever operating piece 26c of the sector gear 26 is spaced from the gear contact portion 23h of the opening lever 23, while the closing lever operating portion 26d is spaced from the second arm 20c of the closing lever 20 in the draw-in releasing position. This position corresponds to the initial position of the sector gear 26 that is detected by the sector gear position detection sensor 33 by the pressure of the pressing member 34 that is fixed to the sector gear 26 against the switch leaf 33a. The opening lever 23 is prevented from rotating in the F4-direction of the extension spring 25 to be held in the opening position by the engagement of the rotation restriction wall 23g with the coupling projection 12h of the hook 12. As described above, when the opening lever 23 is in the opening position, the opening lever detection switch 31 is in an switch-ON state with the switch operating piece 23e pressing a switch leaf 31a of the opening lever detection switch 31. In addition, the control board 40 of the electronic control unit 32 detects a door-open state shown in FIG. 13 from a combination of an input signal indicating an OFF state of the ratchet detection switch 30 and an input signal indicating an ON state of the opening lever detection switch 31.

Upon the striker S entering the striker entry groove 1 la and pressing the second leg portion 12d by a closing operation of the back door 102, the hook 12 is rotated in the counterclockwise direction toward a draw-in commencement position shown in FIG. 14 from the striker releasing position shown in FIG. 13 against the biasing force F1 of the torsion spring 16 while holding the striker S in the striker holding groove 12b. Thereupon, the ratchet pressure projection 12f of the hook 12 presses the stepped portion 13e of the ratchet 13 so that the ratchet 13 rotates in the clockwise direction to the unlatching position shown in FIG. 15 from the latching position shown in FIG. 13 against the biasing force F2 of the torsion spring 17. This rotation of the ratchet 13 to the unlatching position causes the switch operating piece 13f to press the switch leaf 30a, thus causing the ratchet detection switch 30 to be turned ON from the OFF state (T2).

The rotation restriction wall 23g of the opening lever 23 has a predetermined length in the lengthwise direction of the second arm 23c, and when the hook 12 is in the range from the striker releasing position shown in FIG. 13 to a position immediately before reaching the draw-in commencement position shown in FIG. 14, the rotation restriction wall 23g is in contact with the coupling projection 12h of the hook 12 to prevent the opening lever 23 from rotating toward the closing position (clockwise direction), so that the opening lever 23 remains held in the opening position. Thereafter, upon the hook 12 reaching the draw-in commencement position shown in FIG. 14, the coupling projection 12h of the hook 12 is disengaged from the position at which the coupling projection 12h is against the rotation restriction wall 23g so that the prevention of rotation of the hook 12 is released, and so that the opening lever 23 rotates to the closing position shown in FIG. 14 by the biasing force F4 of the extension spring 25 (T3). Upon the opening lever 23 rotating to the closing position, the outer arc surface 23f2 of the opening lever 23 presses the control projection 21c of the interlinking lever 21 toward the closing position, which causes the interlinking lever 21 to rotate in the clockwise direction about the pivot 22 by the biasing force F3 of the extension spring 25 from the coupling disengaging position shown in FIG. 13 to the coupling position shown in FIG. 14. As a result, the coupling projection 12h of the hook 12 comes in contact with the base of the coupling recess 21b of the interlinking lever 21, so that the hook 12 is held in the draw-in commencement position by the interlinking lever 21. This state corresponds to the half-latched state shown in FIG. 14. During the transition of the lock mechanism 10 from the door-open state shown in FIG. 13 to the half-latched state shown in FIG. 14 (including the time the hook 12 is in the striker releasing position and the time the hook 12 is in the draw-in commencement position), the side surface of the closing lever 20 continues to contact the upright wall 11i, so that the closing lever 20 is held in the draw-in releasing position even when the lock mechanism 10 is in the half-latched state. The rotation of the opening lever 23 to the closing position causes the switch operating piece 23e to stop pressing the switch leaf 31a, thus causing the opening lever detection switch 31 to be turned OFF from the ON state (T3). Thereafter, the electronic control unit 32 detects the half-latched state shown in FIG. 14 from a combination of an input signal indicating an ON state of the ratchet detection switch 30 and an input signal indicating an OFF state of the opening lever detection switch 31.

The interlinking lever 21 and the opening lever 23 are both rotated in the clockwise direction when the back door 102 moves from the open state (a state where it is positioned in the vicinity of the fully-closed position) shown in FIG. 13 to the half-latched state shown in FIG. 14; however, during such clockwise rotations of the interlinking lever 21 and the opening lever 23, the control projection 21c of the interlinking lever 21 relatively changes the position thereof in the interlinking-lever control groove 23f in the widthwise direction thereof to change to the state (shown in FIG. 14) in which the control projection 21c is in contact with the outer arc surface 23f2. Additionally, in this state, the interlinking lever 21 is prevented from rotating toward the coupling disengaging position by the engagement between the control projection 21c and the outer arc surface 23f2.

Upon the detection of the half-latched state, the control board 40 of the electronic control unit 32 drives the motor 27a of the motor unit 27 in the forward direction (T4). Thereupon, due to the engagement between the pinion 27b and the gear portion 26b, the sector gear 26 is rotated in the clockwise direction with respect to FIG. 14 (T5), and this rotation of the sector gear 26 causes the closing lever operating portion 26d to press the second arm 20c of the closing lever 20 to thereby rotate the closing lever 20 in the counterclockwise direction from the draw-in releasing position shown in FIG. 14 to the draw-in position shown in FIG. 15. This also causes the hook 12, which is integrated with the closing lever 20 via the interlinking lever 21 (and is prevented from rotating toward the striker releasing position by the coupling recess 21b), to rotate in the counterclockwise direction from the draw-in commencement position shown in FIG. 14 to the striker holding position shown in FIG. 15, so that the striker S is drawn deeply into the striker entry groove 11a by the striker holding groove 12b of the hook 12. At this stage, the interlinking lever 21 moves integrally with the closing lever 20 about the pivot 14 while making the control projection 21c slide on the outer arc surface 23f2 of the interlinking-lever control groove 23f (at this time the rotational center of the outer arc surface 23f2 is coincident with the pivot 14) with the coupling recess 21b and the coupling projection 12h remaining engaged with each other. Additionally, during the time the opening lever 23 is held in the closing position, the interlinking lever 21 is prevented from rotating (rotating on the pivot 22) in a direction (toward the coupling disengaging position) to release the engagement between the coupling recess 21b and the coupling projection 12h by the engagement between the outer arc surface 23f2 and the control projection 21c. In other words, the outer arc surface 23f2 functions as a guide surface which determines the path of the rotational movement of the interlinking lever 21 during the closing operation of the back door 102 from the half-latched state.

During the rotation of the combination of the hook 12 and the closing lever 20 in the draw-in direction of the striker S from the half-latched state shown in FIG. 14, the circular arc surface 12g that is formed at the end of the second leg portion 12d of the hook 12 comes in sliding contact with the circular-arc surface portion 13d of the ratchet 13, and the ratchet 13 is held in the unlatching position against the biasing force F2 of the torsion spring 17 in a manner similar to the case of the half-latched state shown in FIG. 14. During this stage, the opening lever 23 is also held in the closing position in a manner similar to the case in the half-latched state. Namely, a state where the ratchet detection switch 30 and the opening lever detection switch 31 are ON and OFF, respectively, continues. Thereafter, a rotation of the hook 12 to the striker holding position shown in FIG. 15 causes the circular arc surface 12g to escape upward from a position facing the circular-arc surface portion 13d to thereby release the prevention of rotation of the ratchet 13, which causes the ratchet 13 to rotate toward the latching position (in the counterclockwise direction) from the unlatching position by the biasing force F2 of the torsion spring 17, so that the rotation-restriction stepped portion 13c is engaged with the ratchet-engaging stepped portion 12e as shown in FIG. 15. Due to this engagement between the rotation-restriction stepped portion 13c and the ratchet-engaging stepped portion 12e, the hook 12 is prevented from rotating in the direction toward the striker releasing position, so that the lock mechanism 10 comes into the fully-latched state (the door fully-closed state), in which the striker S is completely held in the inner part of the striker entry groove 11a. The counterclockwise rotation of the ratchet 13 when the rotation-restriction stepped portion 13c is brought into engagement with the ratchet-engaging stepped portion 12e causes the switch operating piece 13f to stop pressing the switch leaf 30a, thus causing the ratchet detection switch 30 to be turned OFF from the ON state (T6). Namely, each of the ratchet detection switch 30 and the opening lever detection switch 31 is turned OFF, thereby the fully-latched state being detected.

Upon the detection of the fully-latched state, the control board 40 of the electronic control unit 32 continues to drive the motor 27a in the forward direction by a predetermined overstroke amount in order to ensure a latched state and thereafter drives the motor 27a reversely in the door opening direction (T7). This reverse driving of the motor 27a is for returning the sector gear 26 which has been rotated to the position shown in FIG. 15 by the closing operation to the initial position shown in FIG. 13, and the motor 27a is stopped (T9) upon the sector gear position detection sensor 33 detecting, by the pressure of the pressing member 34 against the switch leaf 33a, that the sector gear 26 has returned to the initial position thereof (T8). In this motor stopped state, the closing lever operating portion 26d is disengaged from the second arm 20c, so that the pressure force on the closing lever 20 from the sector gear 26 is released. However, as described above, the hook 12 is prevented from rotating in the clockwise direction with respect to FIG. 15 (in the direction toward the striker releasing position) due to the engagement thereof with the ratchet 13, and the closing lever 20 which is integrated with the hook 12 via the interlocking lever 21 is also prevented from rotating in the clockwise direction (in the direction toward the draw-in releasing position) against the biasing force F4 of the extension spring 25. In other words, the fully-latched state is maintained.

In addition, in the fully-latched state as shown in FIG. 15, i.e., in the fully-closed state of the back door 102, the upper opening 41b of the tubular cover 41a faces obliquely downwards, and the wire harness 43 extends obliquely downwards from the connector 43a toward the bent portion 43b; accordingly, even when water such as rain water is adhered to the wire harness 43 (or even when water adhered to the back door 102 flows to the wire harness 43), this water does not adhere to the inside of the tubular cover 41a or the control board 40 through the upper opening 41b after flowing toward the connector 43a from the bent portion 43b through the surface of the wire harness 43. Likewise, the lower opening 42b of the tubular cover 42a faces obliquely downwards, and the wire harnesses 35, 36, 37 and 39 extend obliquely downwards from the connector 42 toward the bent portion 35a, 36a, 37a 39a, respectively; accordingly, even when water such as rain water is adhered to the wire harnesses 35, 36, 37 and 39, this water does not adhere to the inside of the tubular cover 42a or the control board 40 through the lower opening 42b after flowing toward the connector 42 from the bent portions 35a, 36a, 37a and 39a through the surface of the wire harnesses 35, 36, 37 and 39.

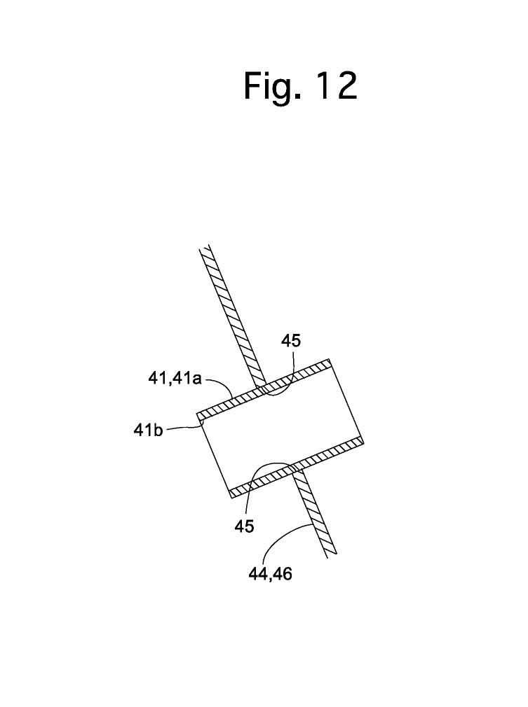

In addition, the portion of the inclined flat plate portion 46 which is positioned above the upper connecting opening 45 is inclined to the vertical direction as shown in FIG. 12, and therefore, when water is adhered to the surface of the inclined flat plate portion 46, this water flows downward through the surface of the inclined flat plate portion 46 to proceed toward the upper connecting opening 45. However, since the lengthwise direction of the tubular cover 41a is orthogonal to the inclination direction of the inclined flat plate portion 46, the water flowed to the upper connecting opening 45 flows toward the upper opening 41b side (downward) after adhering to the surface (upper surface) of the tubular cover 41a, so that this water does not flow toward the control board 40 through the surface of the tubular cover 41a.

Additionally, at this time, since the lower opening 42b of the tubular cover 42a faces obliquely downwards and the wire harnesses 35, 36, 37 and 39 extend obliquely downwards from the connector 38 toward the bent portions 35a, 36a, 37a and 39a as shown in FIG. 2, this water does not adhere to the inside of the tubular cover 42a or the control board 40 through the lower opening 42b after flowing toward the connector 38 from the bent portions 35a, 36a, 37a and 39a through the surfaces of the wire harnesses 35, 36, 37 and 39.

Upon an opening operation switch (not shown) which is electrically connected to the control board 40 being turned ON in the fully-latched state (T10), the motor 27a is driven in the reverse direction (T11) to rotate the sector gear 26 in the counterclockwise direction from the initial position shown in FIG. 13 (T12). Thereupon, the opening lever operating piece 26c presses the gear contact portion 23h, which causes the opening lever 23 to rotate counterclockwise from the closing position shown in FIG. 15 toward the opening position against the biasing force F4 of the extension spring 25 so that the opening lever detection switch 31 is turned ON from the OFF state (T13). This counterclockwise rotation of the opening lever 23 causes the inner arc surface 23f1 of the interlinking-lever control groove 23f to press the control projection 21c, thus causing the interlinking lever 21 to rotate counterclockwise (toward the coupling disengaging position) about the pivot 22. Thereupon, this rotation of the interlinking lever 21 causes the engagement between the coupling recess 21b and the coupling projection 12h to be released, to thereby release the coupling (via the interlocking lever 21) between the hook 12 and the closing lever 20 from each other. In addition, the ratchet pressure projection 21d of the interlinking lever 21 that rotates in the counterclockwise direction presses the pressed piece 13g of the ratchet 13 to rotate the ratchet 13 in the clockwise direction from the latching position to the unlatching position against the biasing force F2 of the torsion spring 17 (T14).

This rotation of the ratchet 13 to the unlatching position causes the engagement between the rotation-restriction stepped portion 13c and the ratchet-engaging stepped portion 12e, i.e., the prevention of rotation of the hook 12, to be released, which causes the hook 12 to rotate toward the striker releasing position shown in FIG. 13 from the striker holding position shown in FIG. 15 by the biasing force F1 of the torsion spring 16. The closing lever 20, the engagement of which with the hook 12 has been released, is also rotated in the clockwise direction toward the draw-in releasing position shown in FIGS. 13 and 14 from the draw-in position shown in FIG. 15 by the biasing force F4 of the extension spring 25; in accordance with this rotation, the control projection 21c of the interlinking lever 21 moves in the interlinking-lever control groove 23f toward the lower end thereof while sliding on the inner arc surface 23f1. Additionally, during the time the opening lever 23 is held in the opening position, the interlinking lever 21 is prevented from rotating (rotating on the pivot 22) in a direction (toward the coupling position) to make the coupling recess 21b and the coupling projection 12h re-engaged with each other by the engagement between the inner arc surface 23f1 and the control projection 21c. In other words, the inner arc surface 23f1 functions as a guide surface which determines the path of the rotational movement of the interlinking lever 21 during the opening operation of the back door 102 from the fully-latched state.

Upon the interlinking lever 21 moving downward by a predetermined amount of movement following the rotation of the closing lever 20 toward the draw-in releasing position, the pressure of the ratchet pressure projection 21d of the interlinking lever 21 against the pressed piece 13g of the ratchet 13 in a direction toward the unlatching position is released. However, during the time until the hook 12 reaches the striker releasing position shown in FIG. 13 from the moment the engagement between the rotation-restriction stepped portion 13c and the ratchet-engaging stepped portion 12e is released, the circular arc surface 12g of the second leg portion 12d of the hook 12 presses the circular-arc surface portion 13d of the ratchet 13 so that the ratchet 13 continues to be held in the unlatching position against the biasing force F2 of the torsion spring 17. More specifically, the amount of rotation of the closing lever 20 from the draw-in position (FIG. 15) to the draw-in releasing position (FIG. 14) is substantially the same as the amount of rotation of the hook 12 from the striker holding position (FIG. 15) to the draw-in commencement position (FIG. 14), and when performing the opening operation, the pressure of the interlinking lever 21 on the ratchet 13 toward the unlatching position is released at a stage before the closing lever 20 reaches the draw-in releasing position shown in FIG. 14. On the other hand, the pressure of the second leg portion 12d of the hook 12 on the ratchet 13 in a direction toward the unlatching position continues for a longer period of time than the pressure of the interlinking lever 21 on the ratchet 13, and it is not until the engagement between the circular arc surface 12g and the circular-arc surface portion 13d is released, upon the ratchet pressure projection 12f moving over the stepped portion 13e of the ratchet 13 after the hook 12 reaches the striker releasing position (FIG. 13), that the ratchet 13 is allowed to rotate to the latching position. Thereafter, the ratchet 13 rotates and returns to the latching position from the unlatching position by the biasing force F2 of the torsion spring 17 (T15) for the first time after the aforementioned allowance of rotation of the ratchet 13 takes place. Namely, the aforementioned signals representing a door-open state that respectively indicate an OFF state of the ratchet detection switch 30 and an ON state of the opening lever detection switch 31 are not input until the hook 12 reaches the striker releasing position.

Upon the detection of the door-open state of the back door 102, the control board 40 of the electronic control unit 32 continues to drive the motor 27a in the reverse direction by a predetermined overstroke amount in order to ensure a latch released state and thereafter drives the motor 27a forwardly in the door closing direction (T16). This forward driving of the motor 27a is for returning the sector gear 26, which has been rotated counterclockwise from the initial position shown in FIG. 13 when performing the opening operation, to the initial position, and the motor 27a is stopped (T18) upon the sector gear position detection sensor 33 detecting that the sector gear 26 has returned to the initial position thereof (T17), so that the lock mechanism 10 returns to the door-open state of the back door 102 shown in FIG. 13.

Additionally, upon the back door 102 moving to the fully-open state as shown in FIG. 17, the upper opening 41b of the tubular cover 41a and the lower opening 42b of the tubular cover 42a face obliquely upwards. However, at this time, the wire harness 43 extends obliquely downwards from the bent portion 43b toward the opposite side from the connector 43a as shown in the drawing; accordingly, even when water such as rain water is adhered to the wire harness 43 (to a portion thereof which is positioned on the opposite side of the bent portion 43b from the connector 43a), this water does not flow toward the connector 43a from the bent portion 43b through the surface of the wire harness 43. Therefore, water does not adhere to the inside of the tubular cover 41a or the control board 40 through the upper opening 41b. Likewise, the wire harnesses 35, 36, 37 and 39 extend obliquely downwards from the bent portions 35a, 36a, 37a and 39a toward the opposite side from the connector 38, respectively; accordingly, even when water such as rain water is adhered to the wire harnesses 35, 36, 37 and 39 (to portions thereof which are positioned on the opposite side of the bent portions 35a, 36a, 37a and 39a from the connector 38), this water does not flow toward the connector 38 from the bent portions 35a, 36a, 37a and 39a through the surfaces of the wire harnesses 35, 36, 37 and 39. Therefore, water does not adhere to the inside of the tubular cover 42a or the control board 40 through the lower opening 42b.

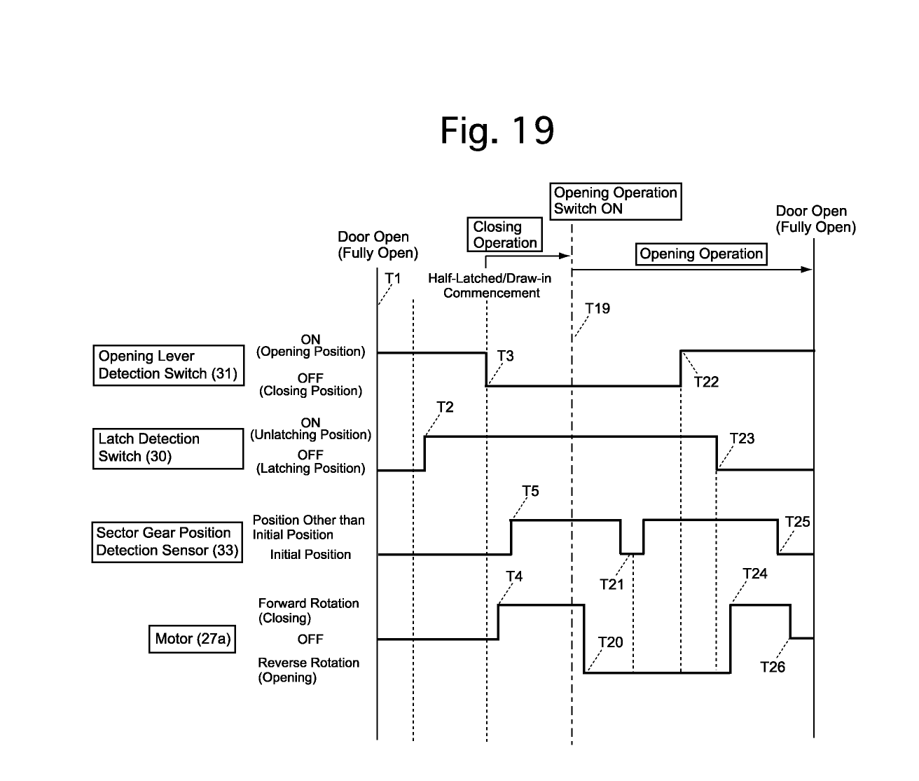

FIG. 19 shows a process performed in the case where the opening (closure-canceling) operation is performed by an operation of the aforementioned opening operation switch during the time the lock mechanism 10 moves from the half-latched state shown in FIG. 14 until coming into the fully-latched state shown in FIG. 15. Operations are the same as those of the above described normal operations until when the motor 27a is driven forward, in response to an input of the signal representing the half-latched state (in which the ratchet detection switch 30 is ON and the opening lever detection switch 31 is OFF), to rotate the sector gear 26 clockwise with respect to FIG. 14 to thereby press and rotate the closing lever 20 toward the draw-in position (T5). At this stage, upon the opening operation switch being turned ON before the lock mechanism 10 comes into the fully-latched state (T19), the control board 40 of the electronic control unit 32 switches the driving direction of the motor 27a from forward to reverse (T20). Thereupon, the sector gear 26 stops pressing the closing lever 20 via the closing lever operating portion 26d. This causes the combination of the hook 12 and the closing lever 20 to return to a position in the half-latched state shown in FIG. 14 by the biasing force F1 of the torsion spring 16 and the biasing force F3 of the extension spring 25. Although the sector gear 26 temporarily returns to the initial position (T21), the sector gear 26 continues to be driven in the reverse direction without the motor 27a being stopped. Thereupon, the opening lever operating piece 26c of the sector gear 26 presses the gear contact portion 23h to rotate the opening lever 23 counterclockwise toward the opening position from the closing position against the biasing force F4 of the extension spring 25, and this operation is detected by the opening lever detection switch 31 (T22).

When the opening lever 23 rotates to the opening position in the half-latched state shown in FIG. 14, a predetermined idle running time (corresponding to the section in which the contact point of the control projection 21c is switched from the outer arc surface 23f2 to the inner arc surface 23f1) elapses, and thereafter, the inner arc surface 23f1 of the interlinking-lever control groove 23f presses the control projection 21c, which causes the interlinking lever 21 to rotate from the coupling position, in which the interlinking lever 21 is engaged with the coupling projection 12h of the hook 12, to the coupling disengaging position. This causes the engagement between the hook 12 and the closing lever 20 to be released, thus causing the hook 12 to solely rotate toward the striker releasing position shown in FIG. 13 from the draw-in commencement position shown in FIG. 14 by the biasing force F1 of the torsion spring 16. Upon the hook 12 reaching the striker releasing position, the pressure of the circular arc surface 12g of the second leg portion 12d against the circular-arc surface portion 13d is released, so that the ratchet 13 rotates from the latching position to the unlatching position, and this operation is detected by the ratchet detection switch 30 (T23). This produces a signal indicating the door-open state of the back door 102, in which the ratchet detection switch 30 is OFF and the opening lever detection switch 31 is ON. Upon input of this signal, similar to the case when normal operations are performed, the motor 27a is driven forward after being driven reverse continuously by a predetermined amount of overstroke (T24) to return the sector gear 26 to the initial position (T25) and subsequently the back door 102 returns to the door-open state shown in FIG. 13 by stopping the motor 27a (T26).

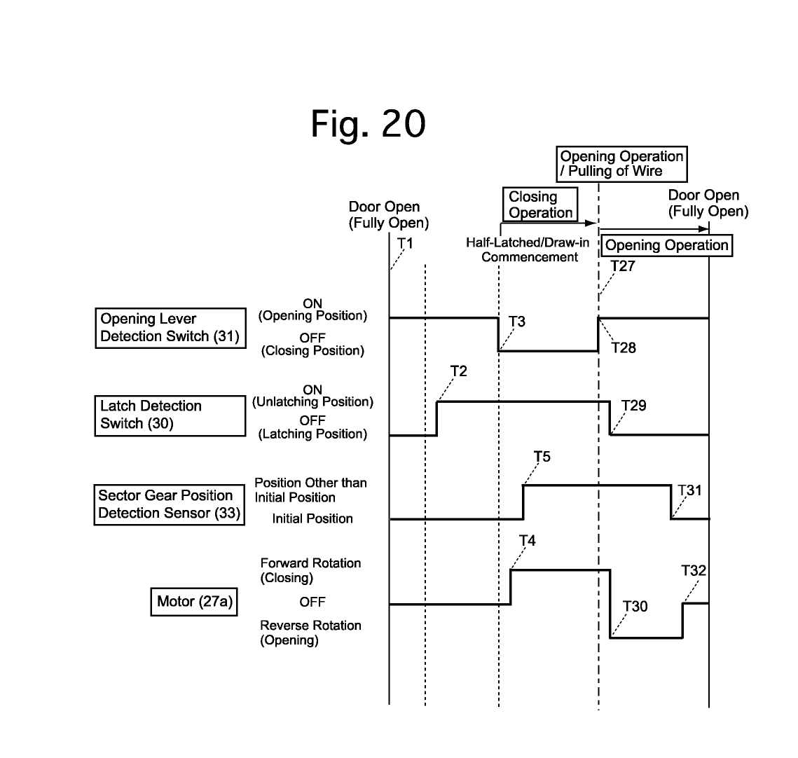

FIG. 20 shows a process performed in the case where a mechanical opening (closure-canceling) operation is performed via the emergency release handle or the key apparatus instead of the aforementioned opening operation switch during the time the lock mechanism 10 moves from the half-latched state shown in FIG. 14 until coming into the fully-latched state shown in FIG. 15. Operations are the same as those of the above described normal operations until when the motor 27a is driven forward upon detection of the signal representing the half-latched state (in which the ratchet detection switch 30 is ON and the opening lever detection switch 31 is OFF) to rotate the sector gear 26 clockwise with respect to FIG. 14 to thereby press and rotate the closing lever 20 (T5). At this stage, an operation of the key apparatus and the emergency release handle or the key apparatus (T27) causes a force pulling the first arm 23b upward to be applied to the opening lever 23, thus causing the opening lever 23 to rotate from the closing position to the opening position, so that the opening lever detection switch 31 is switched from the OFF state (closing position) to the ON state (opening position) (T28). This rotation of the opening lever 23 causes the inner arc surface 23f1 of the interlinking-lever control groove 23f to press the control projection 21c of the interlinking lever 21, thus causing the interlinking lever 21 to rotate (rotate on its axis) counterclockwise about the pivot 22 to thereby be disengaged from the coupling projection 12h of the hook 12. Accordingly, the hook 12, the engagement of which with the closing lever 20 has been released, is rotated toward the striker releasing position shown in FIG. 13 by the biasing force F1 of the torsion spring 16. Subsequently, upon the hook 12 reaching the striker releasing position, the pressure of the circular arc surface 12g of the second leg portion 12d on the circular-arc surface portion 13d is released, which causes the ratchet 13 to rotate from the latching position to the unlatching position, so that the ratchet detection switch 30 is turned OFF from the ON state (T29). The door-open state of the back door 102 is detected from a combination of this OFF state of the ratchet detection switch 30 and the ON state of the opening lever detection switch 31. Upon this detection of the door-open state of the back door 102, the control board 40 of the electronic control unit 32 switches the driving direction of the motor 27a from forward, which is for closing, to reverse (T30), which causes the sector gear 26 to rotate toward the initial position from the position where the sector gear 26 presses the closing lever 20. Upon the sector gear position detection sensor 33 detecting that the sector gear 26 returns to the initial position thereof (T31), the motor 27a is stopped (T32); consequently, the lock mechanism 10 returns to the door-open state of the back door 102 shown in FIG. 13.

As described above, in the present embodiment of the lock mechanism 10, the motor unit 27 can be controlled precisely at all times by the control board 40 because water adhered to the back door 102 (the wire harnesses 35, 36, 37, 39, 43 and others) does not flow inside of the tubular covers 41a and 42a or the control board 40 when the back door 102 is either open or closed.

In addition, the sector gear 26 can be precisely controlled by the circuit board 40 because rotation of the sector gear 26 to the initial position can be reliably detected by the sector gear position detection switch 33 and the pressing member 34.

Additionally, the lock mechanism 10 can be miniaturized compared with conventional closer mechanisms because the sector gear position detection switch 33 is mounted to a surface of the base plate 11 which faces the sector gear 26.

Additionally, the formation of the support projection 11j and the annular stepped portion ilk on the base plate 11 and the formation of the proximal facing portion 26e and the spaced facing portion 26f on the sector gear 26 make it possible to dispose the sector gear position detection switch 33 between the base plate 11 and the sector gear 26 and prevent the sector gear 26 and the sector gear position detection switch 33 from interfering with each other. Additionally, the sector gear 26 can be rotated smoothly because the pressing member 34 prevents the sector gear 26 from tilting by contacting the base plate 11 (the annular stepped portion 11k) even when an external force in a direction to make the sector gear 26 tilt toward the base plate 11 is exerted on the sector gear 26 from the pinion 27b or the like. Accordingly, the sector gear 26 (the pressing member 34) and the sector gear position detection switch 33 can be made to operate smoothly.

Additionally, it is easy to form the pressing member 34 into a desired shape (as compared with the case where it is made of metal) because the pressing member 34 is made of resin as a separate member from the sector gear 26. Hence, the position of the sector gear 26 can be detected with precision by the sector gear position detection switch 33 and pressing member 34.

Additionally, the ratchet 13 is made to return to the latching position from the unlatching position upon the hook 12 reaching the striker releasing position, and it is detected that the door is open (latch release/lock release) by referring to this ratchet-returning operation. This configuration makes it possible to detect the door-open state without directly detecting the position of the hook 12, i.e., even if there is no sufficient space for the installation of a detector around the hook 12. In addition, in the lock mechanism 10, the components thereof, including the ratchet detection switch 30 and the opening lever detection switch 31 that serve as detectors, are arranged at predetermined positions on the base plate 11 as a unit, and accordingly, the lock mechanism 10 is easy to handle and requires no troublesome adjustment when installed in a vehicle. Additionally, in the opening operation, since the ratchet 13 does not return to the latching position until the hook 12 reaches the striker releasing position, i.e., until the door lock is fully released, even in the case where the lock mechanism 10 stops during the opening operation due to some error, there is no possibility of this condition being mistakenly detected as a door open condition. For instance, if the signals indicating the door-open state (a combination of a signal indicating an OFF state of the ratchet detection switch 30 and a signal indicating an ON state of the opening lever detection switch 31) are not input within a predetermined period of time during the opening operation, this condition is determined as an error in the opening operation, so that safety can be secured by performing an appropriate process such as a motor stopping process or a warning issuing process.

Additionally, the ratchet controller that achieves the above described operations of the ratchet 13 is configured from a structure having excellent space utilization which includes the small interlinking lever 21 that is pivoted on the closing lever 20 and the interlinking-lever control groove 23f that is formed in the opening lever 23, etc., thus being capable of avoiding an increase in size of the lock mechanism 10.

Although the present invention has been described based on the illustrated embodiment, the present invention is not limited solely to this particular embodiment. For instance, although the above illustrated embodiment is a door lock device of the back door 102 to which the present invention has been applied, the present invention can also be applied to a vehicle door other than the back door 102 (e.g., a side door or a trunk lid).

In addition, the present invention can also be applied to a lock mechanism different from a closer mechanism. For instance, the present invention can also be applied to a type of lock mechanism in which lock is released by rotating a ratchet by the pressing force of a lever which is rotated by a driving force of a motor, wherein a hook and the ratchet are accommodated in a single housing, wherein the motor and the lever that is rotated by the motor are accommodated in a different housing and wherein the lever and the ratchet are made to face each other by connecting the two housings.

In addition, the pressing member 34 can be formed from metal and be integrally formed with the sector gear 26.

Additionally, rotation of the sector gear 26 to a position other than the initial position (e.g., the position shown in FIG. 15) can be detected by the sector gear position detection switch 33 (and the pressing member 34) by changing the installation position of the sector gear position detection switch 33 with respect to the base plate 11.

### INDUSTRIAL APPLICABILITY

According to the vehicle door closure mechanism according to the present invention, the base member and the closer mechanism can be miniaturized compared with conventional closer mechanisms because the position detection sensor that detects the position of the sector gear in the rotational direction thereof is provided on a surface of the base member which faces the sector gear.

### EXPLANATIONS OF LETTERS OR NUMERALS

10 Door Lock Device (Closer Mechanism)
11 Base Plate (Base Member)
11a Striker Entry Groove
11j Support Projection
11k Annular Stepped Portion
12 Hook
12b Striker Holding Groove
12e Ratchet-Engaging Stepped Portion (Engaging Portion)
12f Ratchet Pressure Projection (Ratchet Controller)
12g Circular Arc Surface (Ratchet Controller/Ratchet Holder)
12h Coupling Projection (Opening Lever Holder)
13 Ratchet
13c Rotation-Restriction Stepped Portion
13d Circular-Arc Surface Portion (Ratchet Controller/Ratchet Holder)
13e Stepped Portion (Ratchet Controller)
13f Switch Operating Piece
13g Pressed Piece (Ratchet Controller/Interlinking-Lever Linkup Portion)
16 Torsion Spring
17 Torsion Spring (Ratchet Biaser)
18 Stopper Member (Stopper)
20 Closing Lever
20b First Arm
20c Second Arm
20d Recess
20g Stopper Surface (Stopper)
21 Interlinking Lever (Ratchet Controller)
21b Coupling Recess
21c Control Projection
21d Ratchet Pressure Projection
23 Opening Lever (Control Lever)
23b First Arm
23c Second Arm (Arm Portion)
23d Handle Interlinking Hole
23e Switch Operating Piece
23f Interlinking-Lever Control Groove (Control Slot)
23f1 Inner Arc Surface (Projection Operating Surface)
23f2 Outer Arc Surface
25 Extension Spring (Closing Lever Biaser/Control Lever Biaser)
26 Sector Gear (Motor-Operated Driving Mechanism)
26c Opening Lever Operating Piece
26d Closing Lever Operating Portion
26e Proximal Facing Portion
26f Spaced Facing Portion
27 Motor Unit
27a Motor
27b Pinion
27c Socket
30 Ratchet Detection Switch (Detector/First Switch)
31 Opening Lever Detection Switch (Detector/Second Switch)
32 Electronic Control Unit (ECU)
33 Sector Gear Position Detection Sensor
34 Pressing Member
35 36 37 Wire Harness (First Wire Harness)
38 Connector
39 Wire Harness (First Wire Harness)
40 Control Board
40a Notch
41 Upper Connector (Second Connector)
41a Tubular Cover
41b Upper Opening (Opening)
42 Lower Connector (First Connector)
42a Tubular Cover
42b Lower Opening
43 Wire Harness (Second Wire Harness)
43a Connector
43b Bent Portion
44 Covering Member (Casing)
45 Upper Connecting Opening (Connecting Opening)
46 Inclined Flat Plate Portion
47 Stepped Portion
48 Locking Portion
49 Locking Hole
50 End Face Portion
51 Locking Lug
52 Locking Hole
54 Body Member (Casing)
55 Cutout
56 Locking Lug
57 Lower Connecting Opening
S Striker
W Opening Operation Wire
100 Vehicle Body
101 Rear Opening (Opening)
102 Back Door (Door)

1. A vehicle door closer mechanism comprising:
a base member which is fixed to one of a vehicle body and a door which opens and closes an opening of said vehicle body;
a hook which is provided on said base member and is rotatable between a striker holding position at which said hook is engaged with a striker that is provided on, and projects from, the other of said vehicle body and said door, and a striker releasing position at which said hook is not engaged with said striker;
a ratchet which is provided on said base member and rotatable between a latching position at which said ratchet is engaged with said hook to hold said hook in said striker holding position and an unlatching position at which said ratchet does not hold said hook in said striker holding position;
a sector gear which is rotatably supported by said base member and rotates said hook toward said striker holding position by rotating in one direction;
a pressing member which is provided on and projects from said sector gear;
a motor which rotates a pinion that is engaged with said sector gear to drive and rotate said sector gear in said one direction; and
a position detection sensor which issues a detection signal by being pressed by said pressing member upon said sector gear being positioned at a predetermined position, said position detection sensor being provided on a facing surface of said base member which faces said sector gear.

2. The vehicle door closer mechanism according to claim 1, wherein said sector gear is made of metal, and
wherein said pressing member is made of resin.

3. The vehicle door closer mechanism according to claim 1, wherein said facing surface of said base member and said pressing member face each other while forming a clearance therebetween.

4. The vehicle door closer mechanism according to claim 1, wherein said sector gear comprises:
a proximal facing portion, a distance of which from said facing surface of said base member is small; and
a spaced facing portion, a distance of which from said facing surface is greater than that from said proximal facing portion and which extends in a circumferential direction about a rotation center of said sector gear, wherein said position detection sensor is provided on a portion of said facing surface which faces said spaced facing portion.
